(19) United States
(12) Patent Application Publication
(10) Pub. No.: US 2010/0107461 A1
(43) Pub. Date: May 6, 2010

(54) Scrolling display device and method

(76) Inventor: William Carter, Dyer, IN (US)

Correspondence Address: RYNDAK & SURI LLP, 200 W. MADISON STREET, SUITE 2100, CHICAGO, IL, 60606, US

(21) Appl. No.: 12/290,768

(22) Filed: Nov. 3, 2008

(51) Int. Cl. G09F 11/18; F21V 14/08

(52) U.S. Cl. 40/514; 362/280

(57) ABSTRACT

A scrolling display device and method are provided in accordance with the invention. The scrolling display device includes an LED illuminator panel that provides light and a support surface for a flexible image-containing web that can be positioned adjacent and at least in close proximity to the surface of the LED illuminator panel to backlight and display that portion of the web. The web can be selectively moved to display desired images contained on the web.

### FIELD OF THE INVENTION

The present invention relates to a scrolling display device and a method for displaying images. More particularly, the present invention relates to a scrolling display device and method that is particularly suited for displaying relatively large images such as in a quick-service restaurant.

### BACKGROUND OF THE INVENTION

Various types of menu boards and scrolling devices are known in the art for displaying advertising messages and the like.

However, there is a need for a device and method that is capable of displaying a selected one or more images from a plurality of images or media frames. In addition, a need exists for such a device and method that is relatively low cost and has a thin profile. A need further exists for such a display device that simulates the image appearance of a flat panel LED or plasma monitor or television.

### SUMMARY OF THE INVENTION

In accordance with the present invention, a scrolling display device is provided. The scrolling display device includes an LED illuminator panel typically having a smooth web-supporting surface. The scrolling display device of the invention further includes a web drive mechanism associated with the LED illuminator panel for moving a flexible image-containing web adjacent and at least in close proximity to the surface of the LED illuminator panel to backlight and permit display of the web portion that is adjacent the LED illuminator panel.

In accordance with one aspect of the invention, the LED illuminator panel is at least substantially planar. In another embodiment, the LED illuminator panel can be curved to a desired degree, and may have a surface that is a section of a cylinder.

In one embodiment, the LED illuminator panel is a flat panel LED that emits white light.

In accordance with the invention, the LED illuminator panel defines a display window for the scrolling display device. The LED illuminator panel is relatively rigid so that it is self-supporting and also provides a supporting smooth surface for the flexible web.

In accordance with another aspect of the present invention, the web drive mechanism that is associated with the LED illuminator panel is configured to selectively scroll the web back and forth over the LED illuminator panel. Alternatively, the drive mechanism can be configured to selectively scroll a continuous web over the LED illuminator panel. In one embodiment, the web drive mechanism is comprised of a pair of selectively driven spools located on each of opposed sides of the LED illuminator panel for selectively scrolling the web back and forth over the LED illuminator panel by winding the web on one of the spools while unwinding the web on the other of the spools.

In accordance with another aspect of the invention, the scrolling display device includes a control system for selectively driving a chosen one of the spools to display a selected portion of the web on the LED illuminator.

The flexible web typically has a plurality of discrete frame images disposed on the web. The images may be of a size and configuration to permit display of at least an entire one of the frame images on the LED illuminator panel. The frame images may form an integral part of the web.

In accordance with one embodiment, at least portions of the frame images are at least semi-transparent. In addition, the resolution of the frame images contained on the web may be of a relatively high resolution. For example, the resolution of the images may be at least 200, 400, 600, 1,200 or more dots per inch (dpi) or equivalent. The images may also be high resolution photograph transparencies. The images may be in color or black and white, such as photographic slides, for example. The displayed frame image of the web illuminated by the LED illuminator panel can simulate a flat panel LED image, such as that displayed by an LED or plasma monitor or television. Yet, the high resolution display can be economically achieved as only a relatively inexpensive LED illuminator panel and a relatively inexpensive black and white or color slide image is needed.

Typically, the web will be configured to at least substantially span the LED illuminator panel. A web guide member may be provided that is associated with the LED illuminator panel and extends longitudinally along the direction of web travel over the LED illuminator panel to help maintain the web in at least close proximity to the LED illuminator panel. Preferably, the web is in substantial contact with the LED illuminator panel and the web guide member helps achieve this.

In accordance with another aspect of the present invention, a method of displaying information is provided. The method includes providing a scrolling display device composed of an LED illuminator panel having a substantially smooth web supporting surface, a web drive mechanism associated with the LED illuminator panel for moving a flexible image-containing web adjacent and at least in close proximity to the surface of the LED illuminator panel to backlight and permit display of the web portion that is adjacent the LED illuminator panel. The method further includes loading a flexible web having a plurality of frame images thereon of a size to permit display of the frame image on the scrolling display device of at least an entire one of the frame images, positioning a selected frame image adjacent and in at least close proximity to the surface of the LED illuminator panel and activating the LED illuminator panel to emit LED light to illuminate the selected frame image.

In accordance with another aspect of the method of the invention, the method further includes providing a high resolution frame image of at least 600 dpi on the web, the display frame image simulating a high resolution image displayed directly by a flat panel LED, such as an LED monitor or television.

### BRIEF DESCRIPTION OF THE DRAWINGS

FIG. 1 is a perspective view of a scrolling display device in accordance with the invention;

FIG. 2 is another perspective view of the scrolling display device of FIG. 1;

FIG. 3A is a front elevation view of the display device of FIG. 1;

FIG. 3B is a front elevation view of the scrolling display device of FIG. 1 illustrating a warning feature in accordance with one embodiment of the invention;

FIG. 4 illustrates an exploded perspective view of the scrolling display device of FIG. 1; and

FIG. 5 illustrates an exploded perspective view of an alternative embodiment scrolling display device in accordance with the invention.

### DETAILED DESCRIPTION OF THE INVENTION

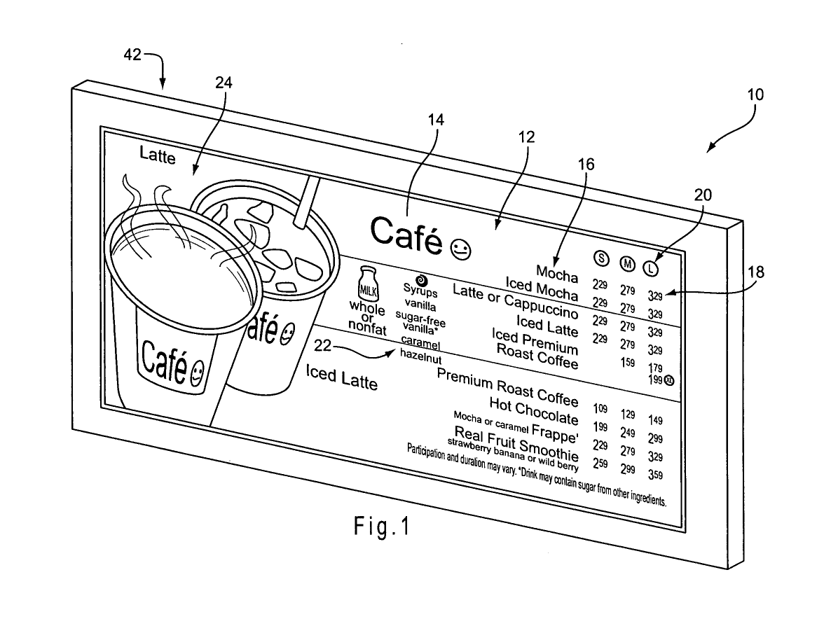

Referring to the Figures generally and in particular to FIG. 1, there is illustrated a scrolling display device 10 in accordance with the present invention. Scrolling display device 10 provides a relatively large display frame 12 that is backlighted. Display frame 12 can be relatively large such as on the order of about 8 square feet and as illustrated in the Figures, display frame 12 has dimensions of approximately 24 inches×50 inches and thus is particularly suitable for displaying images having aspect ratios of about 16:9 or greater such as 2.1:1 or greater, for example. Thus, landscape or panoramic views can be readily displayed in accordance with the present invention. Of course, any desired size, dimensions and aspect ratio can be utilized.

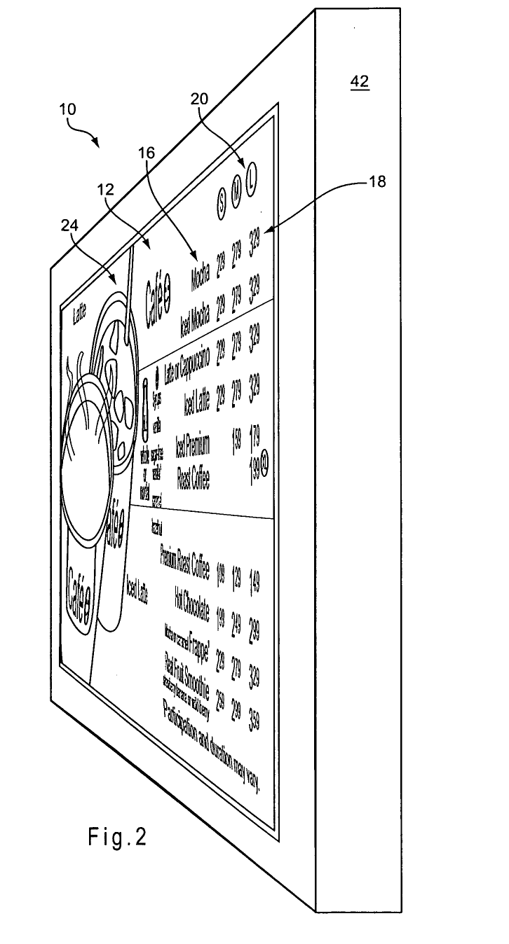

FIG. 2 is a more extreme perspective view of scrolling display device 10 and illustrates the relative thinness thereof. Thus, scrolling display device 10 is particularly well suited to be fastened to a wall surface without any provision for allowing for significant depth. Thus, scrolling display device 10 may be constructed to have approximately 8 square feet of viewing area for display frame 12 and the thickness of scrolling display device 10 can be about 2 inches.

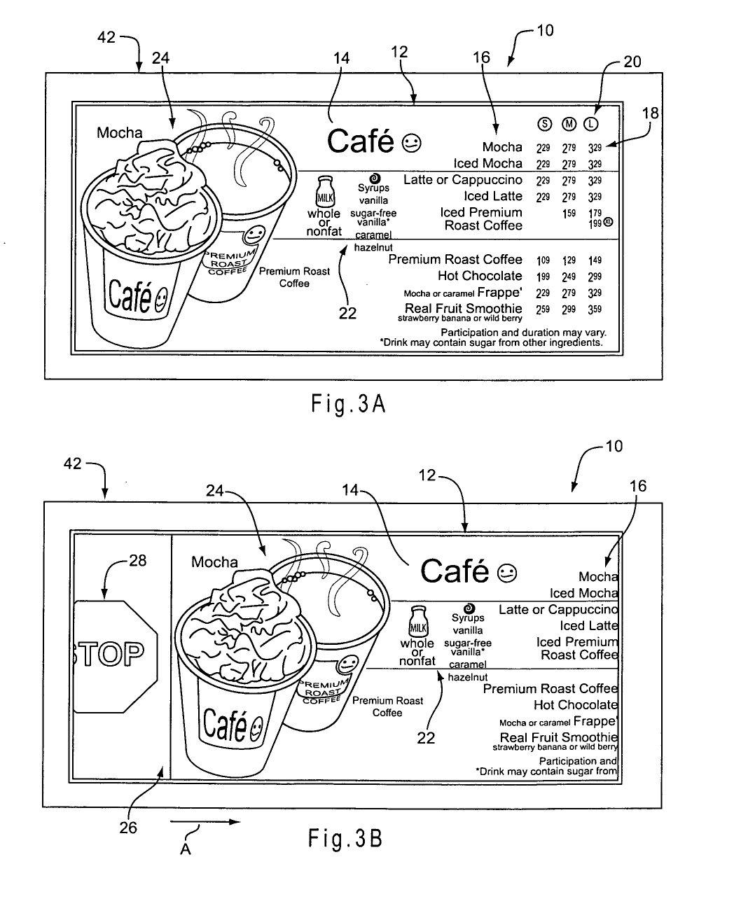

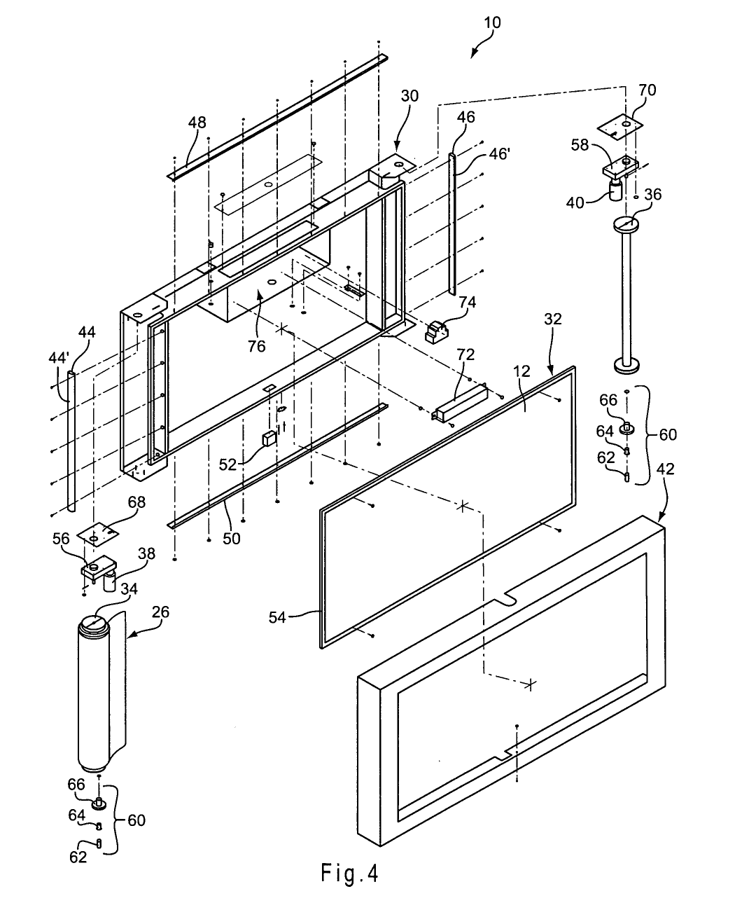

As a result of the large area of the display frame 12, a substantial amount of information can be provided in a single frame, as illustrated in FIGS. 1-3A. For example, as shown in FIG. 3A, nine different beverages are listed in three different sizes with the price for each being included as well as other choices for the beverages including whole or non-fat milk, and various flavored syrups. In addition, there is ample space for depiction of the actual product in a format that is attractive to the consumer.

Thus, as illustrated in FIGS. 1-3A, display frame 12 can display a relatively large single image frame 14 having desired indicia composed of product listings 16, prices 18, sizes 20, extra ingredients or ingredient choices 22 and product images 24. Single image frame 14 is disposed on a flexible web 26 and may form an integral part of flexible web 26. Alternatively, single image frame 14 may be applied as an image that is affixed to a flexible web substrate as a unitary single image frame or as discrete portions. For example, for any image, the pricing or other portion could be separately applied and removed to change product pricing or other information as desired. This would avoid the necessity of replacing flexible web 26. As will be understood by those skilled in the art, single image frame 14 may be composed of any desired indicia and may be composed solely of one or more of the following: numbers, letters, symbols, words, drawings, images, photographs, artwork or other indicia as desired.

Typically, the number of single frame images contained on flexible web 26 will be at least two or more. In this manner, scrolling display device 10 can display any of the images contained on or that are a part of flexible web 26 as will be hereinafter described in detail.

In addition, flexible web 26 can incorporate a visual warning indicia 28, in this case a stop sign symbol, indicating to the operator that the end of flexible web 26 is being approached and that no further movement of flexible web 26 in the direction of arrow A should be made.

In one example of a suitable use of scrolling display device 10, flexible web 26 has three single image frames, in addition to visual warning indicia 28. Each frame may be targeted to a particular time of day or to a particular product type. For example, if the frames are intended for time of day, one frame may be utilized for products typically sold for breakfast or in the morning, another frame may be targeted to products that are typically sold in the afternoon or at lunch and the third frame may be targeted for products typically sold at dinner or in the evening and in addition another frame can be provided for products typically sold later in the evening, after dinner. Of course, scrolling display device 10 is suitable for displaying any type of image as may be desired.

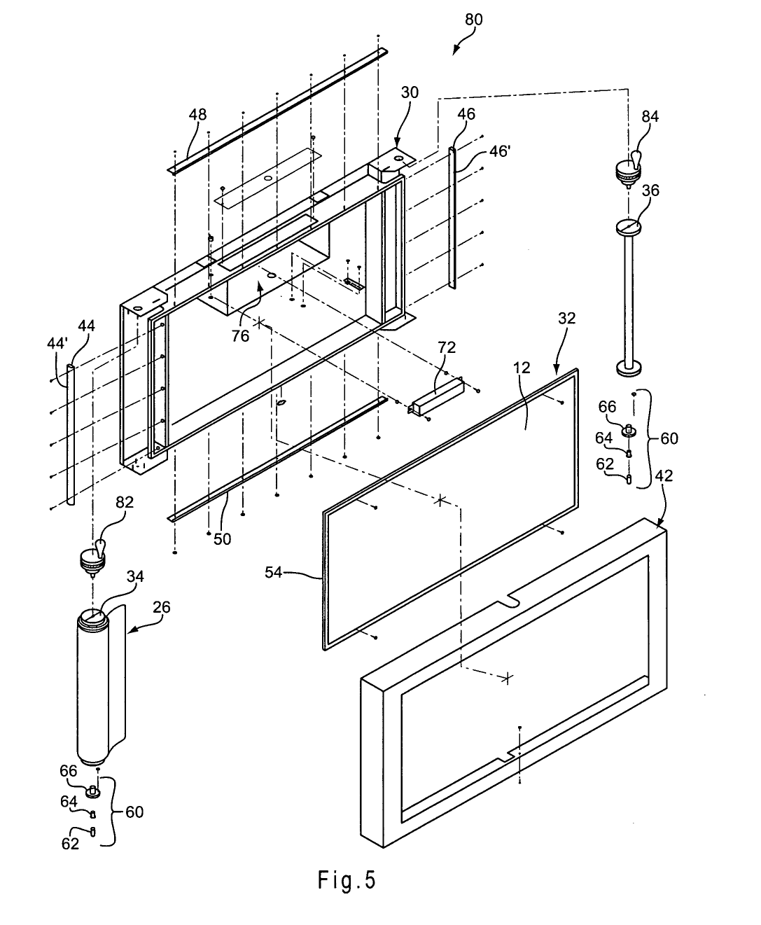

Referring to FIG. 4, there is illustrated an exploded perspective view of scrolling display device 10. Scrolling display device 10 as illustrated includes the following major components: a frame 30, an LED illuminator panel 32, flexible web 26, selectively driven spools 34 and 36, electric motors 38 and 40 for driving selectively driven spools 34 and 36, respectively, a face frame 42 that is mounted to frame 30, nose guides 44 and 46, upper and lower web guides 48 and 50, a controller 52, and various other minor components as will be hereinafter described.

Frame 30 is dimensioned to contain LED illuminator panel 32 and the other components of scrolling display device 10 over which is placed face frame 42 which together with frame 30 forms an enclosure housing all of the internal components of scrolling display device 10.

LED illuminator panel 32 defines display frame 12 in its active illuminated area that corresponds to display frame 12. LED illuminator panel 32 includes a non-illuminated border 54 that allows for mounting of LED illuminator panel 32 to frame 30.

A typical LED illuminator panel for use in accordance with the invention has a substantially smooth web supporting surface which in this case is the surface of display frame 12 over which web 26 traverses. LED illuminator panel 32, in addition to providing a supporting substrate for flexible web 26 also provides low energy efficient backlighting to display the images contained in flexible web 26. As an example, a typical LED illuminator panel having about 8 square feet of lighted area will consume only about 58 watts of electrical energy while providing about 300 foot-candles of light output. In contrast, fluorescent lights would require use of about 290 watts of electrical energy for a similar light output.

Motors 38 and 40 are mounted to frame 30 and transmit rotational energy through gear reducers 56 and 58, respectively, to drive spools 34 and 36. Motors 38 and 40 are controlled by controller 52 which may be a rocker switch. The rocker switch may include three positions, a neutral position where motors 38 and 40 are deactivated, a first position in which web 26 is moved laterally across display frame 12 of LED illuminator panel 32 in the direction of arrow A and a third position in which motors 38 and 40 cause display web 26 to travel in the opposite direction across display frame 12 of LED illuminator panel 32. When display web 26 reaches a desired position on display frame 12, the rocker switch is released and returns to its off position thereby stopping flexible web 26 at the desired display position, such as illustrated in FIG. 3A. For example, continued operation of scrolling display device 10 so that flexible web 26 travels in the direction of arrow A past the left-hand border of the single image frame 14 displayed in FIG. 3A would result in visual warning indicator 28 being displayed as shown in FIG. 3B. Controller 52 could be operated to cause flexible web 26 to travel in the direction opposite to FIG. 3A and FIG. 3B to cause single image frame 14 to return to the position shown in FIG. 3A. Further movement of flexible web 26 in the direction opposite to FIG. 3A would cause flexible web 26 to display the next image immediately to the right of single image frame 14 of FIG. 3A and further movement would cause the next image located further to the right of single image frame 14 to be displayed. Another visual warning indicia (not shown), similar to visual warning indicia 28 could be provided at the opposite end of flexible web 26 to similarly warn the operator of flexible web travel reaching the opposite end of flexible web 26.

Nose guides 44 and 46 provide a rounded surface and are located adjacent respective left and right ends of LED illuminator panel 32 to provide a smooth, rounded or radiused surface 44′ and 46′, respectively, to facilitate the traversal of flexible web 26 from spool 34 to spool 36 and similarly in the opposite direction when scrolling display device 10 is so operated.

Upper and lower web guides 48 and 50 guide flexible web 26 to maintain it in a position adjacent and at least in close proximity to the surface of display frame 12 of LED illuminator panel 32. Upper and lower web guides 48 and 50 as illustrated are L-shaped so that when mounted adjacent and in front of the top and bottom edges of LED illuminator panel 32 they provide a channel through which the edges of flexible web 26 can traverse during movement of web 26 along the surface of display frame 12 and between spools 34 and 36.

Spools 34 and 36 can be conveniently constructed of plastic or any other desired material and thus are relatively inexpensive. In addition, an advertising campaign or current prices as part of a menu promotion may be contained on flexible web 26 and wound onto a single one of spools 34 and 36 and delivered to various restaurants or other locations as needed for subsequent display, such as in a mailing tube, for example. Thus, advertising campaigns can be easily and readily economically changed for a large network of retail establishments, for example.

Spools 34 and 36 can be easily mounted to scrolling display device 10 via a spring-loaded assembly 60 which includes a spring 62, a pin 64 and a spring housing 66. Respective spring 62 exerts an upward force against spring housing 66 which, in turn, urges respective spools 34 and 36 upwardly towards gear reduction mechanisms 56 and 58. This allows easy removal and insertion of spools 34 and 36 into an operating position in scrolling display device 10 by depressing spring housing 66 which, in turn, compresses spring 62. The spools 34 and 36 interface with gear reducers 56 and 58 as desired, and may be a slot (not shown) in gear reducers 56 and 58 and a complementary tab at the end of spools 34 and 36 that fits into the slot or vice-versa. A similar arrangement can be utilized between spring housing 66 and the other end of spools 34 and 36, or even a hole and complementary pin arrangement could be used, as this end of spools 34 and 36 is not driven. Suitable mounting plates 68 and 70 are provided for securing gear reducers 56 and 58 and motors 38 and 40 to frame 30. Other suitable miscellaneous components are also depicted in FIG. 4 including a power supply 72 for LED illuminator panel 32 and a DC power supply 74 for electric motors 38 and 40. Power supplies 72 and 74 can be conveniently mounted in compartment 76 of frame 30.

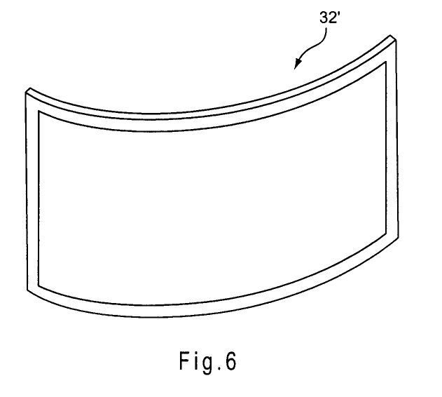

Referring to FIG. 5, there is illustrated an alternate embodiment scrolling display device 80 in accordance with the invention. Scrolling display device 80 is similar to scrolling display device 10 previously described, with the exception that scrolling display device 80 is operated manually and thus does not include motors 38 and 40 and gear reduction devices 56 and 58. All other reference numerals in scrolling display device 80 refer to like elements as described with respect to scrolling display device 10. Spools 34 and 36 can be driven by manually operating hand cranks 82 and 84, respectively. Hand cranks 82 and 84 are connected to spools 34 and 36, respectively, so that rotation of either of hand cranks 82 and 84 cause rotation of spools 34 and 36 to move flexible web 26 in a desired direction.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A scrolling display device comprising:
an LED illuminator panel having a backlighting source and a substantially smooth web supporting surface;
a web drive mechanism associated with the LED illuminator panel for moving a flexible image-containing web adjacent and at least in close proximity to the surface of the LED illuminator panel to backlight and permit display of the web portion that is adjacent the LED illuminator panel.

2. The scrolling display device of claim 1 wherein the LED illuminator panel is at least substantially planar.

3. The scrolling display device of claim 1 wherein the LED illuminator panel is curved.

4. The scrolling display device of claim 1 wherein the LED illuminator panel is a flat panel LED.

5. The scrolling display device of claim 1 wherein the LED illuminator panel defines a display window.

6. The scrolling display device of claim 1 wherein the web drive mechanism is configured to selectively scroll the web back and forth over the LED illuminator panel.

7. The scrolling display device of claim 1 wherein the web drive mechanism is configured to selectively scroll a continuous web over the LED illuminator panel.

8. The scrolling display device of claim 6 wherein the web drive mechanism comprises a pair of selectively driven spools, one of said spools located on each of opposed sides of said LED illuminator panel for selectively scrolling the web back and forth over the LED illuminator panel by winding the web on one of the spools while unwinding the web on the other of the spools.

9. The scrolling display device of claim 8 further comprising a control system for selectively driving a chosen one of said spools to display a selected portion of the web on the LED illuminator.

10. The scrolling display device of claim 1 further comprising a flexible web having a plurality of discrete frame images disposed thereon of a size and configuration to permit display of at least an entire one of said frame images on the LED illuminator panel.

11. The scrolling display device of claim 10 wherein the frame images are an integral part of the web.

12. The scrolling display device of claim 11 wherein at least portions of the frame images are at least semi-transparent.

13. The scrolling display device of claim 10 wherein the web at least substantially spans the LED illuminator panel.

14. The scrolling display device of claim 12 wherein the frame image of the web illuminated by the LED illuminator panel simulates a flat panel LED image.

15. The scrolling display device of claim 1 further comprising:
a web guide member associated with the LED illuminator panel and extending longitudinally along the direction of web travel over the LED illuminator panel to help maintain the web in at least close proximity to the LED illuminator panel.

16. The scrolling display device of claim 1 wherein the LED illuminator panel emits substantially white light.

17. The scrolling display device of claim 8 wherein the drive mechanism comprises a separate drive motor for each spool.

18. A method of displaying information comprising:
providing a scrolling display device comprising an LED illuminator panel having a backlighting source and a substantially smooth web supporting surface, a web drive mechanism associated with the LED illuminator panel for moving a flexible image-containing web adjacent and at least in close proximity to the surface of the LED illuminator panel to backlight and permit display of the web portion that is adjacent the LED illuminator panel;
loading a flexible web having a plurality of frame images thereon of a size to permit display on the scrolling display device of at least an entire one of the frame images;
positioning a selected frame image adjacent and in at least close proximity to the surface of the LED illuminator panel; and
activating the LED illuminator panel to emit LED light to illuminate the selected frame image.

19. The method of claim 18 further comprising providing a high resolution frame image of at least 600 dpi on the web, the displayed frame image simulating a high resolution image displayed directly by a flat panel LED.

20. The method of claim 18, further comprising providing the web drive mechanism which is composed of a pair of selectively driven spools, one of said spools located on each of opposed sides of said LED illuminator panel for selectively scrolling the web back and forth over the LED illuminator panel by winding the web on one of the spools while unwinding the web on the other of the spools, and scrolling the web back and forth over the LED illumination panel to display successively in sequence each of the images on the web.
